(19) United States
(12) Patent Application Publication
(10) Pub. No.: US 2024/0326382 A1
(43) Pub. Date: Oct. 3, 2024

(54) FIREPROOF COMPOSITE PANEL AND FIREPROOF STRUCTURE

(71) Applicant: 3M INNOVATIVE PROPERTIES COMPANY, St. Paul, MN (US)

(72) Inventors: Jiangdong Tong, London, Ontario (CA); Jie Jia, Shanghai (CN); Weijun Zhang, Shanghai (CN); Samantha Peterson, Woodbury, MN (US)

(21) Appl. No.: 18/580,338

(22) PCT Filed: Jul. 22, 2021
(86) PCT No.: PCT/CN2021/107835

§ 371 Date: Jan. 18, 2024

(51) Int. Cl. B32B 15/14; B32B 5/02; B32B 13/06; B32B 15/10; B32B 15/12; B32B 15/20; B32B 21/02

(52) U.S. Cl. CPC B32B 15/14; B32B 5/02; B32B 13/06; B32B 15/10; B32B 15/12; B32B 15/20; B32B 21/02; B32B 2307/304; B32B 2307/3065; B32B 2307/716; B32B 2307/7376; B32B 2607/00

(57) ABSTRACT

A fireproof composite panel and a fireproof structure. The fireproof composite panel (10) comprises a metal layer (11), an aluminum foil layer (15), and a biosoluble insulation layer (13). The biosoluble insulation layer (13) is located between the metal layer (11) and the aluminum foil layer (15). The fireproof structure comprises the fireproof composite panel (10), and is used to seal through openings in a building.

### TECHNICAL FIELD

The present utility model relates to a fireproof composite panel and a fireproof structure, and more specifically, to a fireproof composite panel and a fireproof structure equipped with the fireproof composite panel.

### BACKGROUND ART

The content in the present section only provides background information relating to the present invention, which may not constitute prior art.

Fireproof composite panels have been widely used in various buildings to prevent the spread of fire and smoke in the event of building fire. Common fireproof composite panels are intumescent fireproof composite panels. Intumescent fireproof composite panels are widely used to seal large through openings in buildings in the hope of providing required fireproof performance. Currently commonly used intumescent fireproof composite panels usually comprise a thin steel plate layer, an intumescent insulation layer, an aluminum foil layer, and optionally, a metal mesh layer. When the intumescent fireproof composite panel is heated during use, once the expansion temperature of the intumescent insulation layer is reached, the intumescent insulation layer begins to expand, the expanded volume of which can reach 8 to 10 times the initial volume, which can effectively seal through openings, and prevent the spread of fire and smoke through the through openings. Such intumescent fireproof composite panels can provide a fire resistance integrity limit of up to 4 hours and a fire resistance and heat insulation limit of up to 2 hours. However, for different application environments, fire-resistance rating requirements are different, and therefore requirements for required fire resistance limits and heat insulation limits are also different. A common intumescent insulation layer of an intumescent fireproof composite panel having high fireproof performance uses a thick rubber layer, and is formed by mixing neoprene with sodium silicate and curing the mixture over a long period of time (e.g., up to 6 days). In one aspect, a long curing process is required during a fabrication process for production, rendering the fabrication cycle of said type of fireproof composite panel long and the price usually high. In another aspect, said type of fireproof composite panel is also relatively heavy. If such fireproof composite panels having high protective performance are used in applications having low protection requirements, then wastefulness will be caused to some extent, failing to cost-effectively provide the required protection. Another common intumescent insulation layer of intumescent fireproof composite panels uses conventional refractory ceramic fibers. During preparation and use processes, dust and fine fibers of the refractory ceramic fibers are easily inhaled into the human body, and these fine fibers are not easily degraded nor easily dissolved in the human body, and may produce carcinogens, and thus are harmful to human health and the environment. Society is paying increasingly more attention to environmental protection and health and safety. From the perspectives of environmental protection and health and safety, corresponding requirements are also put forward for fireproof composite panels.

To this end, a fireproof composite panel that can cost-effectively provide required protective performance according to specific applications is desired, which reduces costs while ensuring the required protective performance, and improves the safety and environmental friendliness of the fireproof composite panel.

### SUMMARY

The purpose of the present disclosure is to reduce the fabrication costs of fireproof composite panels while ensuring the protective performance of the fireproof composite panels, and to improve the safety and environmental friendliness of the fireproof composite panels.

One aspect of the present disclosure is to provide a fireproof composite panel, comprising: a metal layer; an aluminum foil layer; and a biosoluble insulation layer located between the metal layer and the aluminum foil layer.

In one embodiment, the biosoluble insulation layer is a biosoluble ceramic fiber layer, a soluble fiber layer, an alkaline earth silicate cotton layer, a synthetic glass fiber layer, an artificial glass fiber layer, an artificial mineral fiber layer, an alkaline earth silicate fiber layer, a magnesium silicate fiber layer, or a high temperature insulation cotton layer.

In one embodiment, the soluble fiber layer is soluble fiber paper, a soluble fiber board, or a soluble fiber blanket.

In one embodiment, the biosoluble insulation layer comprises a plurality of insulation layers stacked on one another.

In one embodiment, the plurality of insulation layers comprise a first insulation layer and a second insulation layer.

In one embodiment, the metal layer is galvanized steel the thickness of which is 0.2 mm to 1 mm; the thickness of the biosoluble insulation layer is 2 mm to 15 mm; and the thickness of the aluminum foil layer is 0.02 mm to 0.2 mm.

Preferably, the thickness of the metal layer is 0.4 mm. Preferably, the thickness of the aluminum foil layer is 0.05 mm. Preferably, the thickness of the biosoluble insulation layer is 5 mm to 8 mm, and more preferably, the thickness of the biosoluble insulation layer is 6 mm.

In one embodiment, a first adhesive layer is formed between the biosoluble insulation layer and the metal layer, a second adhesive layer is formed between the biosoluble insulation layer and the aluminum foil layer, and the first adhesive layer and the second adhesive layer are water-based adhesives or hot-melt adhesives.

Another aspect of the present disclosure is to provide a fireproof structure comprising a concrete structure and a through opening formed in the concrete structure. The fireproof structure comprises the fireproof composite panel according to the present utility model, the fireproof composite panel being fixedly mounted to the concrete structure to block the through opening, and the aluminum foil layer of the fireproof composite panel making contact with the concrete structure.

The fireproof composite panel and the fireproof structure according to the present disclosure simplify the fabrication process of a fireproof composite panel by reasonably designing an insulation layer in the fireproof composite panel, effectively reduce costs, and reduce the weight, and can cost-effectively provide required protective performance, improving the safety and environmental friendliness of the fireproof composite panel while ensuring required protective performance.

### BRIEF DESCRIPTION OF THE DRAWINGS

Embodiments of the present utility model are described below merely by way of example with reference to the accompanying drawings. In the drawings, the same features or components are designated by the same reference numbers, and the drawings are not necessarily drawn to scale, and in the drawings:

FIG. 1 shows a partial cross-sectional view of a fireproof composite panel according to the present disclosure, showing the structure of the fireproof composite panel;

FIG. 2 shows a partial cross-sectional view of a fireproof composite panel according to a modified example of the present disclosure, showing the structure of the fireproof composite panel;

FIG. 3 shows a schematic diagram of a test bench for testing a fireproof composite panel;

FIG. 4 shows a plan of a fireproof composite panel to be subjected to a first test, showing the arrangement of a thermocouple on the fireproof composite panel;

FIG. 5 shows a schematic diagram of conducting a first test on the fireproof composite panel; and

FIG. 6 shows a schematic diagram of conducting a second test on the fireproof composite panel.

### DETAILED DESCRIPTION

The following description is merely illustrative in nature and is not intended to limit the present utility model and applications and uses thereof. It should be understood that throughout the drawings, similar reference numbers indicate the same or similar parts and features. Each drawing only schematically represents the concept and principle of an embodiment of the present utility model, and does not necessarily show the specific dimensions and proportions of each embodiment of the present utility model. Specific parts of specific figures may be exaggerated to illustrate relevant details or structures of embodiments of the present disclosure.

In the description of the embodiments of the present disclosure, directional terms used in relation to “upper”, “lower”, “left”, “right”, “front” and “rear” are described according to the orientation of upper, lower, left, right, front and rear in the views.

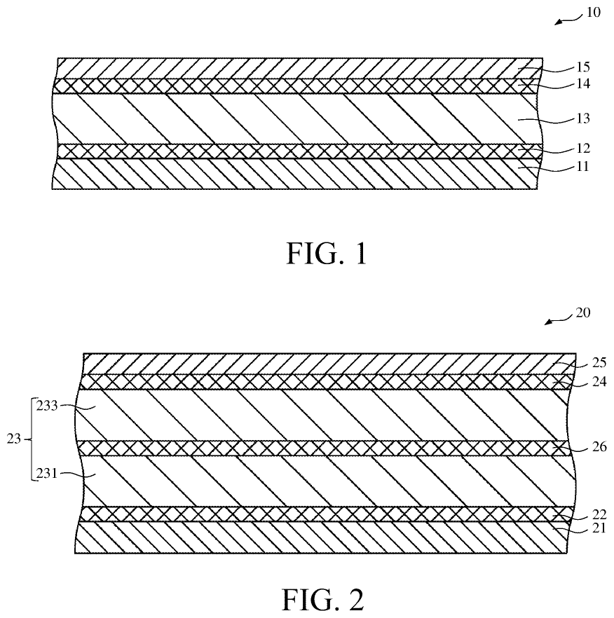

FIG. 1 shows a partial cross-sectional view of a fireproof composite panel according to a first embodiment of the present utility model. As shown in FIG. 1, the fireproof composite panel 10 according to the present utility model comprises a metal layer 11, an insulation layer 13 and an aluminum foil layer 15. The metal layer 11 is made of a high-temperature resistant metal, such as but not limited to galvanized steel, an aluminum alloy, stainless steel, copper, etc. The thickness of the metal layer 11 is 0.2 mm to 1 mm, preferably 0.4 mm.

The insulation layer 13 may be adhered to a side surface of the metal layer 11 (the upper surface in FIG. 1) by means of a first adhesive layer 12. There are no special requirements for the thickness of the first adhesive layer 12, provided that the insulation layer 13 can be adhered to the metal layer 11.

The material and thickness of the insulation layer 13 can be determined according to fire-resistance rating requirements of specific application environments. Preferably, the insulation layer 13 is a biosoluble insulation layer, and can be a biosoluble ceramic fiber layer, a soluble fiber layer, an alkaline earth silicate cotton layer, a synthetic glass fiber layer, an artificial glass fiber layer, an artificial mineral fiber layer, an alkaline earth silicate fiber layer, a magnesium silicate fiber layer, or a high temperature insulation cotton layer. The soluble fiber layer is, for example, soluble fiber paper, a soluble fiber board, or a soluble fiber blanket. These biosoluble insulation layer has excellent high-temperature mechanical properties and corrosion resistance, as well as features such as low thermal conductivity. In addition, the biosoluble insulation layer is degradable, and fine fibers thereof can be quickly dissolved in the human body after being inhaled, which reduces the harm to the human body, and is safe and environmentally friendly. In addition, compared to conventional intumescent insulation layers in fireproof composite panels having the same area (e.g., same length and width), in one aspect, the biosoluble insulation layer weighs significantly less and, in another aspect, the biosoluble insulation layer can be adhered to the metal layer by means of lamination for 2 minutes at 110 degrees Celsius using an adhesive without the need for a long curing process. Therefore, by using the biosoluble insulation layer in the fireproof composite panel, it is possible to reduce the weight of the fireproof composite panel, shorten the fabrication cycle of the fireproof composite panel, reduce costs, and improve safety and environmental friendliness while ensuring the protective performance of the fireproof composite panel. The insulation layer 13 can be prepared using a biosoluble insulation product available on the market, for example, available from Zibo Yuwei Refractory Materials Co., Ltd. (YUFENG) and Shandong Minye Refractory Fiber Co., Ltd. (Minye), for example, YUFENG WOOL® soluble fiber paper and WOOL® soluble boards, etc. produced and sold by Zibo Yuwei Refractory Materials Co., Ltd. In addition, the insulation layer 13 can also be an intumescent product having a suitable thickness. For example, a fireproof blanket of trade name “INTERAM I-10” produced by 3M Company can be used.

The thickness of the insulation layer 13 is 2 mm to 15 mm, preferably 5 mm to 8 mm, and more preferably 6 mm.

The aluminum foil layer 15 can be adhered to the insulation layer 13 by means of a second adhesive layer 14. Similar to the first adhesive layer 12, there are no specific requirements for the thickness of the second adhesive layer 14, provided that the aluminum foil layer 15 can be adhered to the insulation layer 13. Both the first adhesive layer 12 and the second adhesive layer 14 may be a water-based adhesive or a hot-melt adhesive, for example, an adhesive of trade name “1000NF” produced by 3M Company. The thickness of the aluminum foil layer 15 is 0.02 mm to 0.2 mm, and preferably 0.05 mm.

In an example of the fireproof composite panel 10, the metal layer 11 is a galvanized steel plate the thickness of which is 0.5 mm; the insulation layer 13 is YUFENG WOOL® soluble fiber paper the thickness of which is 7 mm; the aluminum foil layer 15 has a thickness of 0.05 mm; the first adhesive layer 12 and the second adhesive layer 14 are both an adhesive of trade name “1000NF” produced by 3M Company.

In the fireproof composite panel according to a modified example of the present utility model, the insulation layer 13 may include a plurality of insulation layers adhered to be stacked on one another. FIG. 2 shows a fireproof composite panel 20 according to a modified example of the present utility model. As shown in FIG. 2, the fireproof composite panel 20 comprises a metal layer 21, an insulation layer 23 and an aluminum foil layer 25. The metal layer 21 is a galvanized steel plate the thickness of which is 0.5 mm; the insulation layer 23 has a thickness of 14 mm and comprises a first insulation layer 231 and a second insulation layer 233 adhered to be stacked on one another. The first insulation layer 231 and the second insulation layer 233 are both YUFENG WOOL® soluble fiber paper produced and sold by Zibo Yuwei Refractory Materials Co., Ltd. The thickness of the aluminum foil layer 25 is 0.05 mm. The first insulation layer 231 is adhered to the metal layer 21 by means of a first adhesive layer 22, the second insulation layer 233 is adhered to the first insulation layer 231 by means of a third adhesive layer 26, and the aluminum foil layer 25 is adhered to the second insulation layer 233 by means of a second adhesive layer 24. The first adhesive layer 22, the second adhesive layer 24 and the third adhesive layer 26 are all adhesives of trade name “1000NF” produced by 3M Company. In other examples according to modified examples of the present utility model, the insulation layer may further comprise more insulation layers adhered to be stacked on one another, for example, three insulation layers.

Both the fireproof composite panel 10 and the fireproof composite panel 20 can be used to seal large through openings in buildings to form a fireproof structure having required fireproof performance, and can be used in applications without cable penetration and can also be used in applications with cable penetration. When the fireproof composite panel 10 and the fireproof composite panel 20 are used to seal through openings in a building, one fireproof composite panel may be mounted on both sides of each through opening to cover the through opening. Alternatively, a fireproof composite panel may be mounted on only one side of the through opening to cover the through opening. When the fireproof composite panel is mounted, the aluminum foil layer of the fireproof composite panel makes contact with a concrete structure in which the through opening is located, the metal layer of the fireproof composite panel faces outward, and the size of each fireproof composite panel is larger than the size of the corresponding through opening, the perimeter of the fireproof composite panel overlaps with the concrete structure by at least 2 inches and the fireproof composite panel is secured to the concrete structure, for example, by means of fastening screws. The concrete structure is, for example, a floor or wall having through openings of a building.

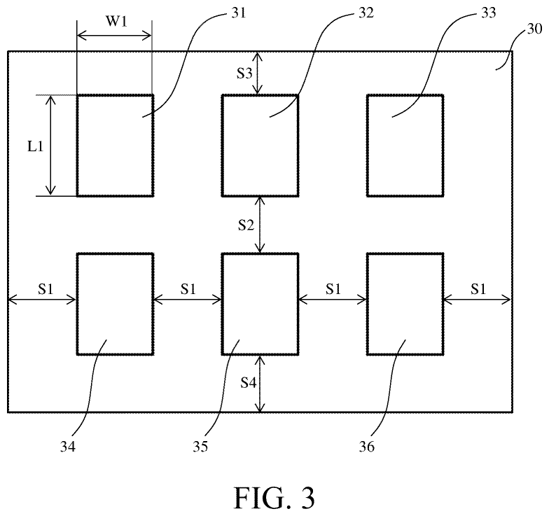

FIG. 3 shows a schematic diagram of a test bench for testing the fireproof performance of a fireproof composite panel. As shown in FIG. 2, the test bench 30 is a horizontal test furnace. The horizontal test furnace is a platform having a concrete structure and is provided with a plurality of through openings. The number of through openings can be configured according to the number of samples to be simultaneously tested. In the example shown in FIG. 3, the test bench 30 is provided with six through openings arranged in two rows, namely, a first through opening 31, a second through opening 32, a third through opening 33, a fourth through opening 34, a fifth through opening 35 and a sixth through opening 36. Each through opening is in the shape of a rectangle having the same dimensions, the length of which is L1, and the width is W1, and the spacing between through openings in the same row in the width direction of the through openings is S1, the spacing between the first row of through openings and the second row of through openings in the length direction of the through openings is S2, the spacing between the first row of through openings and the outer edge of the test bench 30 is S3, and the spacing between the second row of through openings and the outer edge of the test bench 30 is S4. In one example, each through opening has a length L1 of 15 inches, a width W1 of 10 inches, and the spacings S1 and S2 are both 10 inches, and the spacings S3 and S4 are both 8 inches.

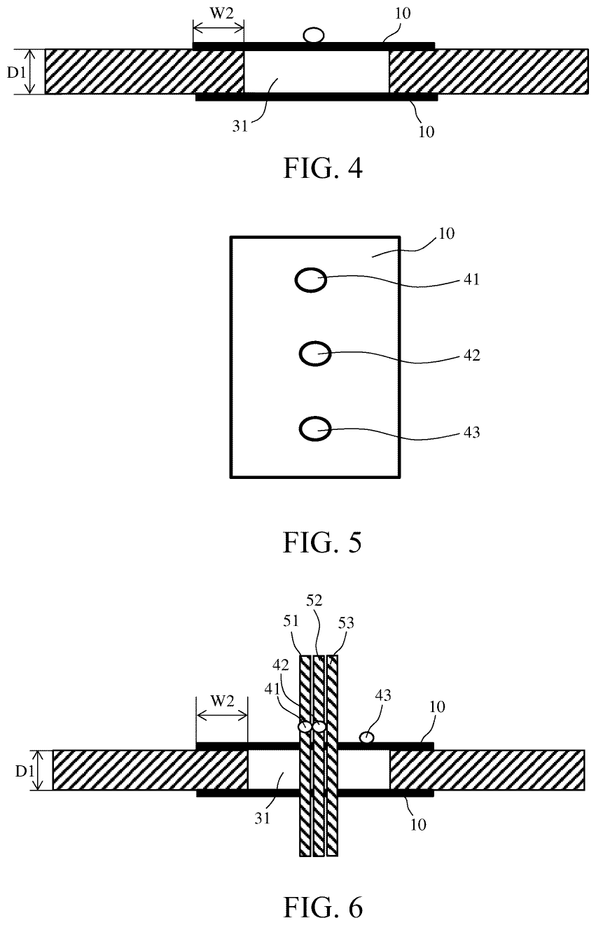

FIG. 4 to FIG. 6 respectively show schematic diagrams of conducting fireproof performance testing on a fireproof composite panel 10 according to the present utility model. When the fireproof performance testing was conducted, the fireproof composite panel 10 was cut into two rectangular panel pieces having a width of 14 inches and a length of 19 inches, which were respectively mounted on upper and lower sides of a corresponding through opening of the test bench 30, for example, on the upper and lower sides of the first through opening 31 of the test bench 30. The aluminum foil layer 15 of each fireproof composite panel 10 made contact with the concrete structure of the test bench 30, and each edge of each fireproof composite panel 10 overlapped with the concrete structure on the perimeter of the first through opening 31 by a width of W2, as shown in FIG. 4 and FIG. 6. In one example, the concrete structure of test bench 30 had a thickness D1 of 4.5 inches and an overlapping width W2 of 2 inches.

When the fireproof performance of the fireproof composite panel 10 in applications without cable penetration was tested, three thermocouples were mounted on the surface of the fireproof composite panel 10 that is mounted on the upper side of the first thorough opening 31, namely, a first thermocouple 41, a second thermocouple 42 and a third thermocouple 43, as shown in FIG. 4 and FIG. 5. The first thermocouple 41, the second thermocouple 42 and the third thermocouple 43 were mounted on the metal layer 11 of the fireproof composite panel 10 and were mounted at equal intervals along the center line in the width direction of the fireproof composite panel 10. The second thermocouple 42 was located at the center of the fireproof composite panel 10.

As shown in FIG. 6, when the fireproof performance of the fireproof composite panel 10 in applications with cable penetration was tested, after the fireproof composite panel 10 was mounted in place on the upper and lower sides of the first penetration opening 31, three cables (i.e., a first cable 51, a second cable 52 and a third cable 53) passed through the fireproof composite panel 10, two thermocouples were mounted on two of the cables, and the other thermocouple was mounted to the fireproof composite panel 10. As shown in FIG. 6, the first thermocouple 41 was mounted to the first cable 51, the second thermocouple was mounted to the second cable 52, and the third thermocouple 43 was mounted to the metal layer 11 of the fireproof composite panel 10. The third thermocouple 43 was located at an intermediate position between the third cable 53 and the edge of the first through opening 31.

In the same manner as above, the fireproof composite panel 20 according to the present utility model was mounted to the corresponding through opening of the test bench 30, for example, to the second through opening 32. Accordingly, other test samples (e.g., other existing fireproof products) could be mounted to other through openings of the test bench 30.

Then, the test bench 30 was started. For protection requirements that a fire resistance integrity limit is 1 hour and a fire resistance and heat insulation limit is also 1 hour, in accordance with the fireproof performance test specification of fireproof sealing materials recorded in the Chinese National Standard GB23864-2009, the fireproof composite panel 10 and the fireproof composite panel 20 were tested. The total test time of a test without cable penetration was 145 minutes, and the total test time of a test with cable penetration was 95 minutes. Experimental data shows that for the fireproof composite panel 10, the fire resistance and heat insulation limit of the test without cable penetration was 100 minutes, and no damage to the fire resistance integrity occurred; the fire resistance and heat insulation limit of the test with cable penetration was 78 minutes, and also no damage to the fire resistance integrity occurred. For the fireproof composite panel 20, regardless of the test without cable penetration or the test with cable penetration, the fire resistance and heat insulation limit exceeded the test time, and no damage to the fire resistance integrity occurred in both tests. That is, until completion of the tests, the fireproof composite panel 20 had still not failed.

In summary, whether with cable penetration or without cable penetration, the fireproof composite panel 10 and the fireproof composite panel 20 according to the present utility model could both provide protection of a fire resistance and heat insulation limit of 1 hour. In addition, further, the fireproof composite panel 20 could provide protection of a fire resistance and heat insulation limit of 2 hours in conditions with cable penetration. Therefore, both the fireproof composite panel 10 and the fireproof composite panel 20 according to the present utility model can meet the protection requirements of fire resistance and heat insulation limit of 1 hour.

The foregoing describes the fireproof composite panel 10 according to the present utility model, the fireproof composite panel 20 according to the modification example, and the fireproof structure equipped with a protective composite panel. The fireproof composite panel and the fireproof structure according to the present utility model can cost-effectively provide required protective performance by reasonably designing the insulation layer in the fireproof composite panel. In particular, by using the biosoluble insulation layer, in one aspect, the fabrication process of the fireproof composite panel is simpler, effectively reducing costs and weight. In another aspect, the biosoluble insulation layer is easily dissolved and can be degraded. Therefore, during the fabrication and use processes of the fireproof composite panel, even if fine fibers of the fireproof composite panel are inhaled into the human body, the fine fibers will be easily dissolved in the human body, which can reduce the harm to the human body and improve the safety and environmental friendliness of the fireproof composite panel.

Herein, exemplary embodiments of the fireproof composite panel and the fireproof structure according to the present disclosure have been described in detail, but it should be understood that the present disclosure is not limited to the specific embodiments described and illustrated in detail above. Without departing from the main purpose and scope of the present utility model, those skilled in the art could make various modifications and variations to the present utility model. All such modifications and variations shall fall within the scope of the present disclosure. Furthermore, all components described herein may be replaced by other technically equivalent components.

1. A fireproof composite panel, characterized by comprising:
a metal layer;
an aluminum foil layer; and
a biosoluble insulation layer located between the metal layer and the aluminum foil layer.

2. The fireproof composite panel according to claim 1, characterized in that the biosoluble insulation layer is a biosoluble ceramic fiber layer, a soluble fiber layer, an alkaline earth silicate cotton layer, a synthetic glass fiber layer, an artificial glass fiber layer, an artificial mineral fiber layer, an alkaline earth silicate fiber layer, a magnesium silicate fiber layer, or a high temperature insulation cotton layer.

3. The fireproof composite panel according to claim 2, characterized in that the soluble fiber layer is soluble fiber paper, a soluble fiber board, or a soluble fiber blanket.

4. The fireproof composite panel according to claim 1, characterized in that the biosoluble insulation layer comprises a plurality of insulation layers stacked on one another.

5. The fireproof composite panel according to claim 4, characterized in that the plurality of insulation layers comprise a first insulation layer and a second insulation layer.

6. The fireproof composite panel according to claim 1, characterized in that
the metal layer is galvanized steel, the thickness thereof being 0.2 mm to 1 mm;
the thickness of the biosoluble insulation layer is 2 mm to 15 mm; and
the thickness of the aluminum foil layer is 0.02 mm to 0.2 mm.

7. The fireproof composite panel according to claim 6, characterized in that the thickness of the metal layer is 0.4 mm, and/or the thickness of the aluminum foil layer is 0.05 mm, and/or the thickness of the biosoluble insulation layer is 5 mm to 8 mm.

8. The fireproof composite panel according to claim 7, characterized in that the thickness of the biosoluble insulation layer is 6 mm.

9. The fireproof composite panel according to claim 1, characterized in that a first adhesive layer is formed between the biosoluble insulation layer and the metal layer, a second adhesive layer is formed between the biosoluble insulation layer and the aluminum foil layer, and the first adhesive layer and the second adhesive layer are water-based adhesives or hot-melt adhesives.

10. A fireproof structure, comprising a concrete structure and a through opening formed in the concrete structure, characterized in that the fireproof structure comprises the fireproof composite panel according to claim 1, the fireproof composite panel being fixedly mounted to the concrete structure to block the through opening, and the aluminum foil layer of the fireproof composite panel making contact with the concrete structure.
